(19) United States
(12) Patent Application Publication
(10) Pub. No.: US 2019/0352001 A1
(43) Pub. Date: Nov. 21, 2019

(54) PROPULSION SYSTEM FOR A SINGLE-ENGINE HELICOPTER

(71) Applicant: SAFRAN HELICOPTER ENGINES, Bordes (FR)

(72) Inventors: Romain THIRIET, Moissy-Cramayel (FR); Camel SERGHINE, Moissy-Cramayel (FR); Alphonse PUERTO, Moissy-Cramayel (FR); Christian SARRAT, Moissy-Cramayel (FR)

(73) Assignees: SAFRAN HELICOPTER ENGINES, Bordes (FR); SAFRAN HELICOPTER ENGINES, Bordes (FR)

(21) Appl. No.: 16/484,428

(22) PCT Filed: Feb. 5, 2018
(86) PCT No.: PCT/FR2018/050282

§ 371 Date: Aug. 7, 2019

(30) Foreign Application Priority Data
Feb. 15, 2017 (FR) 1751235

(51) Int. Cl. B64C 27/12; B64D 27/10; F02C 7/32; F02C 7/36

(52) U.S. Cl. CPC B64C 27/12; B64D 27/10; F02C 7/32; B64D 2041/002; F05D 2220/329; F05D 2270/09; F05D 2270/095; F02C 7/36

(57) ABSTRACT

Propulsion system (8) for a single-engine helicopter (1), comprising: a main engine (9) connected to a front drive shaft (5) and a rear drive shaft (7), respectively, suitable for driving a main gearbox (4) referred to as MGB (4) and a tail gearbox (6) referred to as TGB (6); ⋅ an assistance device (10) attached to the main engine (9); characterised in that said propulsion system (8) is designed in order that the assistance device (10) can mechanically drive the TGB and MGB (6, 4) by introducing power to the rear drive shaft (7).

### TECHNICAL FIELD

The present invention relates to a propulsion system for a single-engine helicopter and more particularly to a propulsion system comprising a main engine and an assistance device.

### STATE OF THE ART

A single-engine helicopter is a helicopter comprising a propulsion system including a single main engine, generally an internal combustion engine and, for example, a turboshaft engine, to drive a main rotor through a main gearbox, referred to as MGB, and a tail rotor through the rear gearbox, referred to as RGB.

The propulsion system can further comprise an assistance device for the helicopter. The assistance device is used in emergency situations to temporarily provide power to the helicopter, and more specifically to the main and rear rotors.

The first case of emergency is a failure of the main engine. In this situation, the pilot initiates a degraded flight procedure referred to as autorotation flight. The assistance device mechanically assists the helicopter during the autorotation flight and in particular during the first and/or last phases of the flight (“flare” before landing). Such an assistance device thus significantly limits the damage caused to the helicopter following an autorotation flight, thus being advantageous in terms of the helicopter immobilisation time.

A second case of emergency is an immediate need for additional power, for example when avoiding obstacles or if there is a temperature inversion at high altitude.

Document FR-A1-3019588 filed by the applicant describes various architectures for the integration of an assistance device. The assistance device comprises a turbine rotationally driving a shaft, supplied by a solid storage gas generator, as well as controlled means for the supply of the drive turbine. The mechanical rotational power of the shaft is, in the present case, used to drive the main rotor of the helicopter by introducing this power, either directly at the level of the MGB, or at the level of a front drive shaft, or at the level of a shaft of a free turbine of the turboshaft engine (main engine).

These types of propulsion systems create sizing problems. Indeed, the integration of such an assistance device in an engine compartment, which is already compact, generates significant modifications both at the level of the helicopter airframe and at the level of the main engine, as well as for the transmission of power from the main engine to the MGB.

Furthermore, the introduction of this power to the free turbine of the main turboshaft engine has several disadvantages.

The first disadvantage is that if the gas supply of the free turbine of the main turboshaft engine fails, it no longer produces engine torque and will decelerate very quickly under the effect of losses caused by aerodynamic friction. These losses can reach several tens of kilowatts (kW). It should therefore be understood that depending on the application mentioned above, i.e. a failure of the main engine or the immediate need for additional power to avoid an obstacle, the motive power actually seen by the main rotor is different, which might surprise the pilot of the helicopter.

A second disadvantage is that by injecting assistance power through the free turbine, it is not possible to provide this assistance power to the main and rear gearboxes in case of failures of the free turbine and/or the components of the turboshaft engine mechanically located downstream therefrom, and in particular the reduction gear of the turboshaft engine, for turboshaft engines provided with such a reduction gear.

A third disadvantage is that a specific interface must be provided on the turboshaft engine to allow the injection of said assistance power to the free turbine.

The prior art also comprises documents US-A1-2012/025032, US-A1-2015/143950 and US-A1-2011/121127.

The purpose of the present invention is therefore to propose a propulsion system for a single-engine helicopter comprising an assistance device that overcomes the abovementioned disadvantages.

### PRESENTATION OF THE INVENTION

For this purpose, the invention proposes a propulsion system for a single-engine helicopter comprising;
a main engine connected to a front drive shaft and a rear drive shaft, respectively able to drive a main gearbox referred to as MGB and a rear gearbox referred to as RGB;
an assistance device secured to the main engine;
characterised in that said propulsion system is configured so that the assistance device can mechanically drive said RGB and MGB by introducing power to said rear drive shaft.

Such a propulsion system requires only a few modifications of the main engine (for example a turboshaft engine), and more broadly of the helicopter. Furthermore, such a propulsion system facilitates the assembly and maintenance of the assistance device. Finally, the integration of the assistance device with the main engine minimises the total weight of the helicopter.

Furthermore, the integration of the assistance device as close as possible to the main engine limits the impacts associated with shifting the centre of gravity of the propulsion system.

Finally, the introduction of power to the rear drive shaft, and therefore kinetically downstream from a power freewheel, overcomes the abovementioned disadvantages relating to the introduction of power to a free turbine of a turboshaft engine.

The propulsion system according to the invention can comprise one or several of the following features, taken individually or in combination:
said assistance device comprises a propulsion device comprising pyrotechnical and/or electro-technical and/or electric and/or hydraulic and/or pneumatic means;
the propulsion device is mechanically connected to said rear drive shaft by means of a gearbox;
said gearbox comprises a first reduction gear and/or a first freewheel configured to transmit the power generated by said propulsion device to said rear drive shaft;
said gearbox comprises means to measure the rotational speed of said propulsion device and/or of said rear drive shaft;
said gearbox comprises the following interfaces:
a first interface coupled to the propulsion device;
a second interface coupled to a first portion of said rear drive shaft, said first portion being mechanically connected to the main engine;
a third interface coupled to a second portion of said rear drive shaft, said second portion being mechanically connected to said RGB;
said first portion of said rear drive shaft is connected to a second freewheel connected to a second reduction gear, said second reduction gear being mechanically connected to said main engine;
the main engine is an internal combustion engine, and preferably a turboshaft engine.

A second object of the invention relates to a helicopter comprising a propulsion system as described above.

### DESCRIPTION OF THE FIGURES

The invention will be better understood, and other details, characteristics and advantages of this invention will become clearer upon reading the following description, provided by way of example and not limited thereto, and with reference to the appended drawings, in which:

FIG. 1 is a schematic view of a single-engine helicopter comprising a propulsion system according to the invention;

FIG. 2 is a detailed view of an assistance device of the propulsion system according to the invention;

FIG. 3 is a rear perspective view of a propulsion system according to the invention.

### DETAILED DESCRIPTION

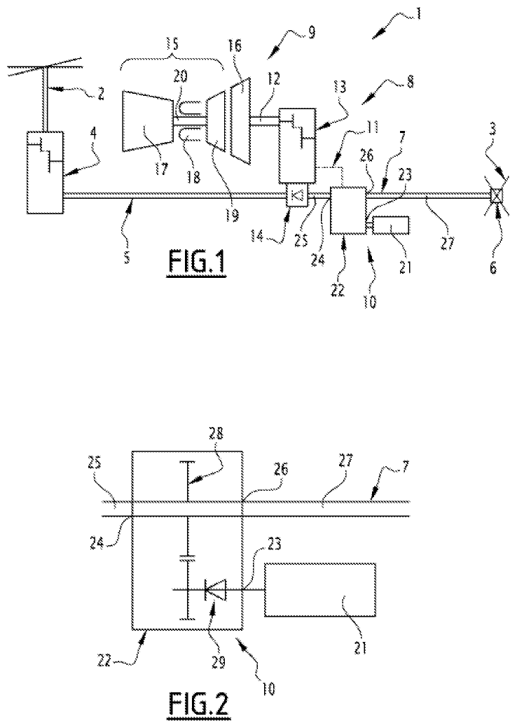

FIG. 1 schematically shows a single-engine helicopter 1 comprising a main rotor 2 driving a rotary wing and a rear rotor 3 commonly referred to as a tail rotor,

More specifically, the main rotor 2 is driven by a main gearbox 4, referred to as MGB 4 (hereinafter referred to as MGB), itself being driven by a front drive shaft 5 (also referred to as a main drive shaft 5). Similarly, the rear rotor 3 is driven by a rear gearbox 6, referred to as RGB 6 (hereinafter referred to as RGB), itself being driven by a rear drive shaft 7. In the present case, the front and rear drive shafts 5, 7 are substantially coaxial.

The helicopter 1 further comprises a propulsion system 8, comprising a main engine 9 and an assistance device 10 used in emergency situations to temporarily provide power to the helicopter 1, and more specifically to the main and rear rotors 2, 3. The assistance device 10 is secured to the main engine 9 by attachment means 11.

The propulsion system 8 is configured so that the assistance device 10 is able to mechanically drive the RGB and the MGB 6, 4 by introducing power to the rear drive shaft 7, in particular in emergency situations.

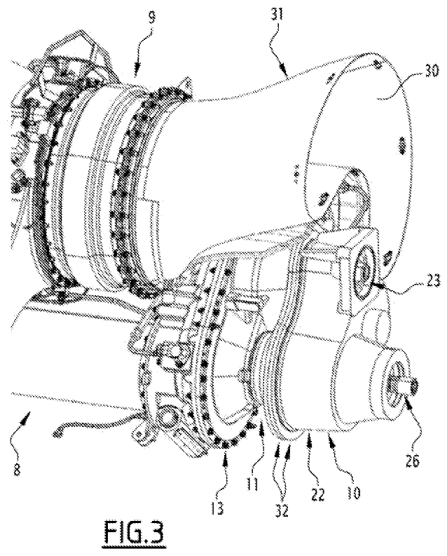

According to the embodiment shown in FIGS. 1 and 3, the main engine 9 comprises an output shaft 12 mechanically connected to the front and rear drive shafts 5, 7 through a reduction gear 13 and a first freewheel 14, called referred to as the propulsion freewheel.

It should be noted that in the present invention, the terms “front” and “rear” associated with the drive shafts 5, 7 are used with respect to the first freewheel 14.

As illustrated in FIGS. 1 and 3, the main engine 9 is in this case a turboshaft engine consisting of a gas generator 15 and a free turbine 16, on which the output shaft 12 is attached. The gas generator 15 comprises, in a known manner, at least one air compressor 17 supplying a combustion chamber 18 a fuel with the compressed air, in order to deliver hot gases to at least one expansion turbine 19 of the gases that rotationally drives the compressor 17 by means of a drive shaft 20. The gases then drive the power transmission free turbine 16. In an alternative version, the main engine 9 can correspond to any type of internal combustion engine.

As shown in FIGS. 1 and 3, the assistance device 10 is here secured to the first reduction gear 13 by attachment means 11 (shown in dotted lines in FIG. 1), such as an assembly with bolts and external flanges. The assistance device 10 is located directly below an outlet mouth 30 of a pipe 31 through which the hot gases are evacuated. The assistance device 10 is (physically) integrated to the turboshaft engine 9 and, in other words, the assistance device 10 and the turboshaft engine 9 form a single unit,

The first reduction gear 13 reduces the rotational speed of the output shaft 12.

The first freewheel 14 is in particular configured to:
enable the transmission of movement to the MGB 4 when the assistance device 10 imposes a rotational speed higher than that imposed by the flight in autorotation, during for example a failure of the main engine 9;
enable the transmission of movement to the MGB 4 when the assistance device 10 imposes a shaft rotational speed (from the reduction gear 13 to the MGB and not the other way) higher than that imposed by the main engine 9.

The assistance device 10 comprises a propulsion device 21 comprising pyrotechnical and/or electro-technical and/or electric and/or hydraulic and/or pneumatic means.

The assistance device 10 can comprise pyrotechnical means such as those disclosed in documents FR-A1-3019588 or FR-A1-3019524. The assistance device 10 can comprise hydraulic means such as those disclosed in document FR-A1-3019221 or in document FR1653789. The assistance device can comprise pneumatic means such as those disclosed in document FR-A1-3024180.

The assistance device 10 is mechanically connected to the rear drive shaft 7.

More specifically, according to the embodiment shown in FIGS. 1 to 3, the propulsion device 21 is mechanically connected to the rear drive shaft 7 by means of a gearbox 22.

The gearbox 22 comprises the following interfaces:
a first interface 23 coupled to the propulsion device 21;
a second interface 24 coupled to a first portion 25 of said rear drive shaft 7, said first portion 25 being mechanically connected to the first freewheel 14;
a third interface 26 coupled to a second portion 27 of said rear drive shaft 7, said second portion 27 being mechanically connected to the RGB 6.

Advantageously, the reduction of the length of the rear drive shaft 7 does not affect the line dynamics of the shaft.

The first and second portions 25, 27 of the transmission shaft 7 are substantially coaxial. Each interface 23, 24, 26 of the gearbox 22 is for example flanged to the corresponding member to enable the transmission of power.

FIG. 2 shows the gearbox 22 that comprises a second reduction gear 28 and a second freewheel 29 configured to transmit the power generated by the propulsion device 21 to the rear drive shaft 7.

According to the embodiment of FIG. 3, the gearbox 22 is made of two parts assembled with one another by means of two peripheral belts 32 placed end-to-end and maintained in position by attachment means not shown.

In the present case, as shown in FIG. 2, the power provided by the assistance device 10 is transmitted to the rear drive shaft 7 through the second freewheel 29 and then through the second reduction gear 28.

In an alternative version, the power provided by the assistance device 10 could be transmitted to the rear drive shaft 7 through the second reduction gear 28 and then through the second freewheel 29.

When the helicopter 1 is not operating properly (only the main engine 9 is working), the second freewheel 29 does not inadvertently drive the propulsion device 21, with the advantage of extending the lifespan thereof. The assistance device 10 is thus independent of the main engine 9.

The second reduction gear 28 adapts the rotational speed of the rear drive shaft 7 to that imposed by the propulsion device 21.

The gearbox 22 comprises means to measure the rotational speed of the shafts inside the gearbox 22, and for example of the propulsion device 21 and/or of said rear drive shaft 7. These measurement means assesses, at every moment and in all flight situations, the rotational speed of the main and rear rotors 2, 3.

In the present case, the second reduction gear 28 comprises a gear set with a single gear. However, this example is in no way limiting, and the second reduction gear 28 can comprise for example several gear sets with, for example, straight teeth and/or several epicyclical gear sets, based on the required reduction.

In an alternative version, several propulsion devices 21 are coupled to the gearbox 22.

During normal operations, the main engine 9 provides all of the power required to drive the MGB and the RGB 4, 6, and consequently the main and rear rotors 2, 3. The power provided by the main engine 9 is transmitted at the output of the first reduction gear 13 by means of the first freewheel 14 to the front and rear drive shafts 5, 7.

In an emergency situation, for example in the event of a main engine 9 failure, the assistance device 10, through the supply of power to the rear drive shaft 7, temporarily increases the rotational speeds of the front and rear drive shafts 5, 7, and consequently of the main and rear rotors 2, 3. The transmission of power from the assistance device 10 to the MGB 4 is made possible because of the first freewheel 14.

1. Propulsion system for a single-engine helicopter comprising:
a main engine connected to a front drive shaft and a rear drive shaft, respectively able to drive a main gearbox referred to as MGB (4) and a rear gearbox referred to as RGB;
an assistance device secured to the main engine;
wherein said propulsion system is configured so that the assistance device can mechanically drive said ROB and MGB by introducing power on said rear drive shaft.

2. System according to claim 1, wherein said assistance device comprises a propulsion device comprising pyrotechnical and/or electro-technical and/or electric and/or hydraulic and/or pneumatic means.

3. System according to claim 1, wherein the propulsion device is mechanically connected to the rear drive shaft by means of a gearbox.

4. System according to claim 3, wherein said gearbox comprises a first reduction gear and/or a first freewheel configured to transmit the power generated by said propulsion device to said rear drive shaft.

5. System according to claim 3, wherein said gearbox comprises means to measure the rotational speed of said propulsion device and/or of said rear drive shaft.

6. System according to claim 3, wherein said gearbox comprises the following interfaces:
a first interface coupled to the propulsion device;
a second interface coupled to a first portion of said rear drive shaft, said first portion being mechanically connected to the main engine;
a third interface coupled to a second portion of said rear drive shaft, said second portion being mechanically connected to said RGB.

7. System according to claim 6, wherein said first portion of said rear drive shaft is connected to a second freewheel connected to a second reduction gear, said second reduction gear being mechanically connected to said main engine.

8. System according to claim 1, wherein the main engine is an internal combustion engine, and preferably a turboshaft engine.

9. Helicopter comprising a propulsion system according to claim 1.
